(19) United States
(12) Patent Application Publication
(10) Pub. No.: US 2011/0231206 A1
(43) Pub. Date: Sep. 22, 2011

(54) METHOD WHICH CREATES A COMMUNITY-WIDE HEALTH INFORMATION INFRASTRUCTURE

(75) Inventor: Robert Daniel Claud, Chicago, IL (US)

(73) Assignee: eCapable, Inc., Chicago, IL (US)

(21) Appl. No.: 13/094,625

(22) Filed: Apr. 26, 2011

Related U.S. Application Data
(63) Continuation of application No. 11/669,635, filed on Jan. 31, 2007, now abandoned.
Application No. 11/669,635 is a continuation-in-part of application No. 11/089,400, filed on Mar. 24, 2005, now abandoned.
(60) Provisional application No. 60/845,859, filed on Sep. 20, 2006.
(60) Provisional application No. 60/842,716, filed on Sep. 7, 2006.
(60) Provisional application No. 60/811,500, filed on Jun. 7, 2006.
(60) Provisional application No. 60/808,662, filed on May 26, 2006.
(60) Provisional application No. 60/799,836, filed on May 12, 2006.
(60) Provisional application No. 60/764,746, filed on Feb. 3, 2006.
(60) Provisional application No. 60/763,727, filed on Feb. 1, 2006.
(60) Provisional application No. 60/556,470, filed on Mar. 26, 2004.
(60) Provisional application No. 60/577,855, filed on Jun. 8, 2004.
(60) Provisional application No. 60/578,189, filed on Jun. 9, 2004.
(60) Provisional application No. 60/598,470, filed on Aug. 3, 2004.
(60) Provisional application No. 60/609,973, filed on Sep. 15, 2004.
(60) Provisional application No. 60/624,516, filed on Nov. 3, 2004.

(51) Int. Cl. G06Q 50/00; G06Q 10/00

(52) U.S. Cl. 705/3

(57) ABSTRACT

A system for a community-wide health information infrastructure incorporates applications of information technology in conjunction with an incremental approach that creates incentives for voluntary participation for health care providers, payers, and patients from the onset. It identifies the hierarchical importance of categories of medical and health information and sets forth a systematic approach to utilize that hierarchy to establish a composite personal medical or health record for each individual.

### CROSS REFERENCE TO RELATED APPLICATIONS

This application is a continuation application of Ser. No. 11/669,635 filed Jan. 31, 2007 which claims priority to U.S. Provisional Application Ser. Nos. 60/763,727, filed Feb. 1, 2006; 60/764,746 filed Feb. 3, 2006; 60/799,836 filed May 12, 2006; 60/808,662, filed May 26, 2006; 60/811,500 filed Jun. 7, 2006; 60/842,716 filed Sep. 7, 2006, and 60/845,859 filed Sep. 20, 2006 and is a continuation in part of U.S. application Ser. No. 11/089,400 filed Mar. 24, 2005, which claims priority to the following U.S. Provisional Applications: Ser. Nos. 60/656,609, filed Feb. 26, 2005; 60/624,516, filed Nov. 3, 2004; 60/609,973, filed Sep. 15, 2004; 60/598,470, filed Aug. 3, 2004; 60/578,189, filed Jun. 9, 2004; 60/577,855, filed Jun. 8, 2004; 60/556,470, filed Mar. 26, 2004, and 60/681,423, filed May 16, 2005; and to U.S. application Ser. No. 11/361,764 filed Feb. 24, 2006 which is a continuation in part of U.S. application Ser. No. 11/089,400 filed Mar. 24, 2005, all of which are incorporated by reference in their entirety herein.

### FIELD OF INVENTION

The present invention generally relates to a novel system and method for the creation of a system that accomplishes the storage and retrieval of personal health information using a methodology and information technology in a manner that overcomes the deficiencies of the prior art.

### DESCRIPTION OF RELATED ART

Since at least 1996, interne browsers have had the ability to create a communications channel between a Client computer and a Central Server, via a Network, without a distinct directive action on the part of the user. The current invention involves novel and unique techniques and methods that take advantage of these abilities that have not been previously implemented or described, and which were not obvious.

The problem addressed by the current invention is the lack of universally accessible, portable, electronic, interoperable, private and secure personal health information within the health care industry. For decades, the need for portable personal health information that moved securely, with the patient, from health care provider to health care provider, regardless of the institutional affiliation of the health care provider, has been recognized. Large payers for health care have, particularly, recognized this need as they frequently pay for tests that are repeated unnecessarily by a physician who apparently is unaware of the previous results of the same test.

Many have proposed, and implemented, solutions to this national problem. To date, no solution has been widely embraced throughout the community as a workable solution to this problem. Solutions that have been proposed fall into four broad categories—representative of the related art in the field—Personal Health Records, Electronic Medical Records, e-prescribing solutions, and Regional Health Information Organizations (RHIO's).

Many providers exist for Personal Health Records, or PHR's. In general, these include systems designed to allow patients to enter their personal health information in a database for subsequent retrieval, although some incorporate claims-based data derived from payer databases. The lack of clinical data—that is, Personal Health Information that is clinician generated—is the major identified weakness of PHR's.

Other related art include systems that have been designed to facilitate electronic prescribing—that is, the ability of a health care provider to use an information system to generate a prescription that is transmitted electronically to a pharmacist. The lack of physician enthusiasm for electronic prescribing is the major identified weakness for electronic prescribing.

Electronic medical record (EMR) systems are health information technology solutions that are designed around health care providers. By design they can be used to store and retrieve personal health information pertaining to unique individuals. Their architecture and design limits their usefulness to individual patients—the individual patient's personal health information, generated by health care providers, is only accumulated if the health care provider who generates said information is an existing user of the EMR system. In addition to cost and lack of physician enthusiasm, the major identified weakness of electronic medical record (EMR) systems is their orientation towards health care providers, hospitals, clinics, and other similar entities and institutions rather than the community.

Regional Health Information Organizations (RHIO's) are networks of electronically stored personal health information designed to be used by health care providers throughout a community to retrieve PHI at the time of patient care. Although many of these exist, they suffer from two ongoing problems which are currently unsolved: ongoing complexity, and lack of proven business model (creating inherent financial instability). The lack of proven business model represents the major identified weakness of a Regional Health Information Organization (RHIO).

One preferred embodiment of the current invention represents a solution to this national problem. It addresses the identified weaknesses of each of the four existing categories. The invention involves unique and novel technology components which are incorporated within a unique and novel approach.

Succinctly, the inventive system creates the platform and framework for a community-wide health information infrastructure that addresses both the specific demands of various participants in the health care industry and the general needs of the nation. The inventive system involves all of the following:

Provider-derived clinical data

Method to create Physician enthusiasm for electronic prescribing

Community-oriented health information technology using the patient as the central integrating factor of previously disparate, disconnected information technology systems.

Clearly self-sustaining business model for the creation of portable, secure

Personal Health Information for a community of individuals, based on an incremental approach that recognizes and incorporates a hierarchy of categories of medical information, which are sub-categories of the entire body of Personal Health Information

Markedly decreased complexity compared to existing known solutions

### SUMMARY OF THE INVENTION

The inventive system specifically addresses the need for community-wide patient-centric health information technology that creates, stores, and retrieves personal health information in a manner that addresses the deficiencies of the existing art.

Aspects of the present invention relate generally to the field of information storage and retrieval, and, more particularly, to the field of electronic medical records, specifically a system that enables the creation, storage, and retrieval of digital medial information that present day computers can both retrieve and interpret. The invention thus relates to the creation of machine-interpretable medical information for storage and later retrieval, using methods that are user-friendly, intuitive, and palatable to physicians and other health care providers relative to other known systems.

Aspects of the current invention builds on the accomplishment of the first principle aspect: the system, which is used to create data that is machine-interpretable, is able, as a second principle aspect, to provide context-sensitive information to the computer user that is based on the application of computer-based rules used to interpret the information entered, in a manner that is more user-friendly, as well as intuitive and palatable to physicians and other health care providers than current systems.

The inventive methods and system accomplish this in a manner that is quicker, more user-friendly and intuitive than any other current known systems. This addresses the usability issue that has, to date, been a major impediment to physician enthusiasm for health information technology systems and thus holds a potential of improved patient safety and care.

The approach taken by the inventive system is feasible specifically due to the novel and unique application of information technology described herein. According to a preferred embodiment of the current invention, medication reconciliation across the continuum of care is the basic building block for a system that incorporates identity management (of both patient and health care provider) and integrates price-formulary awareness at the prescribing decision point. This creates a solution to a newly created business problem for health care providers (e.g. accreditation requirements promulgated by the Joint Commission for Accreditation of Healthcare Organizations) and creates the platform for the accomplishment of the larger goals, e.g. patient-centric health information technology systems with a clearly visible return on investment associated with improved price-formulary awareness at the prescribing point.

The technological solutions used by the inventive system involve novel and unique elements that allow the creation of machine-interpretable data and the real-time display of context-sensitive information via a browser-based user interface. All known solutions that solved these problems prior to the inventive solution involved a client-installed software program, an inefficient user interface, or both.

Elements of the technological solutions incorporated into the inventive system allow for the creation of end-user controlled information access rules while simultaneously allowing for more rapid while secured information retrieval than all known current systems.

Elements of the inventive system allow the end user to capture external ID's—that is, the primary keys of other databases used to identify the unique end user within the other databases. This allows the creation of order from chaos—creating ease of identity management within systems not originally intended to interface with each other.

Elements of the inventive system allow for “no-click” user authentication which requires only proximity of a device for the authentication of the identity of a credentialed system user.

Elements of the inventive system known as “PreText”—create a simple, easy method allowing user to create a template containing mixed data elements for future users to use both as a template for form creation and as a template for the creation of additional templates

According to one embodiment of the current invention, an average user with no additional training can create a data entry template which contains mixed data elements and save it for future use by him/herself or others.

PreText=sentences, paragraphs, or pages of textual information, presented in a brower-based text entry interface, that is the pre-defined template used for form creation and submission. Incorporated are PreScript™ autocomplete selections that effectively create customizable drop-down choices for various sub-elements of the template. There are two user modifying options:

open modifications—allows user to modify any portion of the PreText

closed modifications—allows user to modify only the PreScript™ portions of the PreText

In the following examples, the pre formed text is shown in a plain font, while the customizable sub-element is shown in bold italics.

Health Care
THE PATIENT TWISTED HIS RIGHT ANKLE SUSTAINING A SPRAIN.
Legal
I, JACOB LITTLE, BEING OF SOUND MIND AND DISPOSING MIND,
DO DECLARE THIS TO BE MY LAST WILL AND TESTAMENT
Information Technology
<FORM>
name: <INPUT><BR>
email: <INPUT>
</FORM>

These customizable sub-elements may be accomplished through PreScript™ technology, effectively creating/allowing a drop down list of likely choices but, where appropriate, allowing free text entry also.

Certain features of this approach contribute to the value-add to the community:

allow the user to create new PreText

pre-formed text elements consisting of text that is

(1) user modifiable

(2) not user modifiable

(3) incorporates PreScript™ elements with author-derived autocomplete choices

subsequent users can go from PreScript™ element to PreScript™ element by pushing the Tab button

subsequent users can modify the PreText also (if allowed by author)

The present invention is based on the creation of new and unique communication methods which are based on technology that has existed for more than a decade. Specifically, the present invention draws on the ability of a computer algorithm, resident and running on a server computer which is connected to a client computer via a network, to interpret user entries in a browser window in real time and to display context-sensitive data in response to said user entries in the browser window. This server runs an application which interprets user entries in real time and applies algorithms to the data entered by the user. Where appropriate, the server causes the user interface to display the results of these algorithms to the user.

A first aspect of the present invention involves constraining user entries to a pre-defined vocabulary of possible choices. This is accomplished by displaying, in real time, a list of the available possibilities from within a pre-defined vocabulary in response to the user's individual key-strokes.

A second aspect of the present invention involves the display of context-sensitive information to the user, in real time and in response to user entries—entries which may be defined to a level of granularity of a keystroke.

A third aspect of the present invention involves the display of information specifically pertaining to adverse drug interactions, in real time, occurring prior to the actual prescription of a drug by a physician.

A fourth aspect of the present invention involves the display of information specifically pertaining to checking of dose information entered by a user against an predefined set of dosing rules specific to a drug.

A fifth aspect of the present invention involves the display of information specifically pertaining to appropriate route of administration for a given drug, or a given drug/dose combination.

A sixth aspect of the present invention involves the display of information specifically pertaining to drug-allergy interactions.

A seventh aspect of the present invention involves the display of information specifically pertaining to drug-condition interactions, where condition refers to a medical condition, disease, or disability.

An eighth aspect of the present invention involves the display of information specifically pertaining to drug-food interactions.

A ninth aspect of the present invention involves the display of a static data set of information that is specific to a respective drug.

A tenth aspect of the present invention involves the display of a static data set to the user, in response to user input, that is user-sensitive. This is accomplished by incorporating an identity management algorithm into the algorithm that selects the appropriate Static Data Set, with respect to the user, from which to supply context and user-sensitive data to the user.

An eleventh aspect of the present invention involves the display of a static data set to the user, in response to user input, that is patient-sensitive. This is accomplished by incorporating an identity management algorithm into the algorithm that selects the appropriate Static Data Set, with respect to the patient, from which to supply context and user-sensitive data to the user.

A twelfth aspect of the present invention involves the display of a static data set to the user, in response to user input, that is patient-sensitive. This is accomplished by incorporating an identity management algorithm into the algorithm that selects the appropriate Static Data Set, with respect to both the user and the patient, from which to supply context and user-sensitive data to the user.

A thirteenth aspect of the present invention is to provide a means of storing and retrieving, in a means that is more user friendly than all previous methods, a user's previous responses to the identical Text Entry Interface, by such a means that the user can then select the appropriate response that he desires from a list of his previous responses. This is also accomplished with an identity management algorithm incorporated into the system.

A fourteenth aspect of the present invention is to allow users to enter data that is compliant with a standardized vocabulary, even if they are relatively uninformed about what the standardized vocabulary contains. For example, by means of displaying information that contains internal character sequences—disregarding the initial characters or characters entered by the user—the system could allow a user to select a choice that he was looking for even without knowing how to spell the word or phrase.

A fifteenth aspect of the present invention is a natural migration pathway from dirty data to clean data, as described above. By comparing previous entries to those contained within a standardized list of acceptable entries, the entries that do not comply with the standardized list can be presented to the user for clarification—and the Text Entry Interface incorporated into the system for the user to enter the clarification can incorporate the system as described herein; by this means, the “dirty data” can be eliminated from a database and replaced by “clean data” in an extremely logical and practical way.

A sixteenth aspect of the present invention, in the medical field, is to facilitate research. Any database containing data that is not machine interpretable is much more difficult to conduct research on, whereas any database containing machine interpretable data is much more conducive to research.

A seventeenth aspect of the current invention is a means of displaying cost data for tests, procedures, or drugs, at the time a physician or other healthcare provider is deciding to order such tests, procedures, or drugs.

An eighteenth aspect of the current invention is a means of providing clean data, in the form of a list of the medications a patient is currently taking, to an algorithm that checks the list of medications for adverse drug interactions.

A nineteenth aspect of the current invention is to help the user bidirectionally convey information electronically and remotely with another healthcare information technology system. Clean data enables and facilitates this, dirty data does not.

A twentieth aspect of the present invention involves the display of a static data set of information that is specific to a medical disease or condition.

A twenty-first aspect of the present invention involves “PreText” means sentences, paragraphs, or pages of information, generally textual but sometimes numeric in nature, presented in a browser-based text entry interface that constitutes a pre-defined template used for form creation and submission. Included in these forms (i.e. including in PreText) are two types of variable data:
a. highly constrained data entry options (“PreScript™,” defined above) and
b. poorly or unconstrained data entry options (e.g. free-text).

These and other objects, advantages, features, and aspects of the invention are set forth in the detailed description which follows.

### DETAILED DESCRIPTION OF THE DRAWINGS

In the detailed description which follows, reference will be made to the drawing comprised of the following figures:

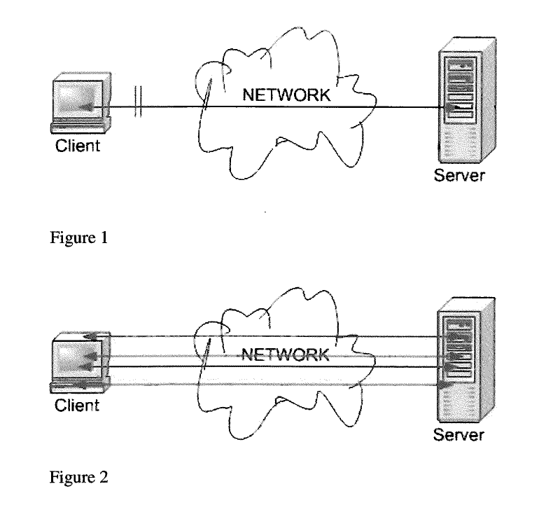

FIG. 1 is a diagrammatic view of the client network arrangement;

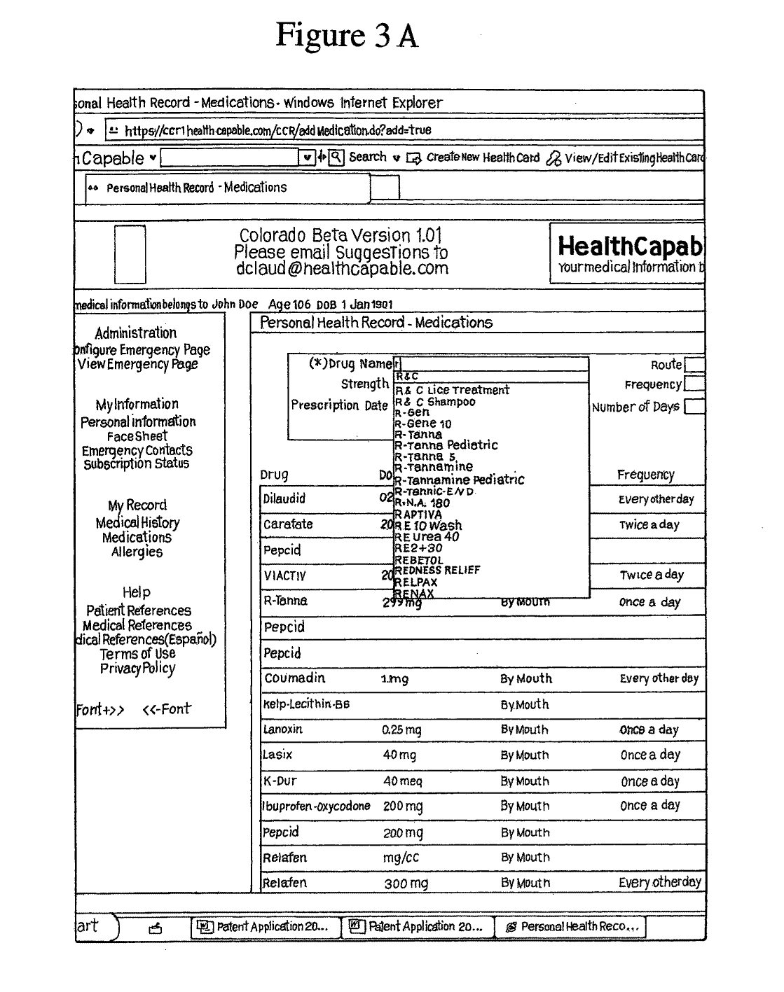

FIG. 2 is a further diagrammatic view of the network relationship between client and server;

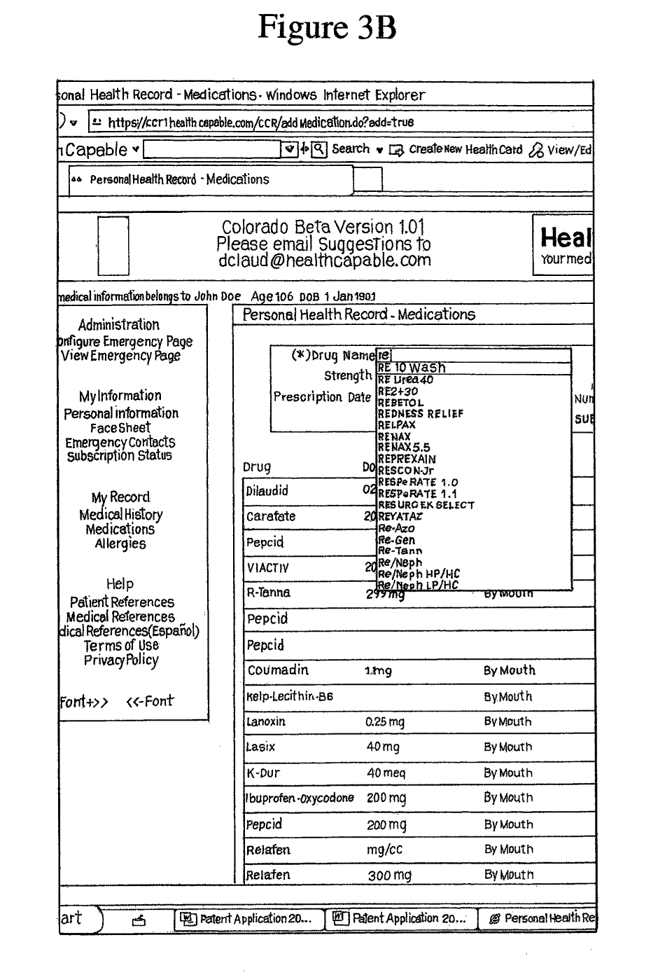

FIG. 3A is a typical health record form;

FIG. 3B is a further health record form;

FIG. 3C is a health record form;

FIG. 3D is another health record form;

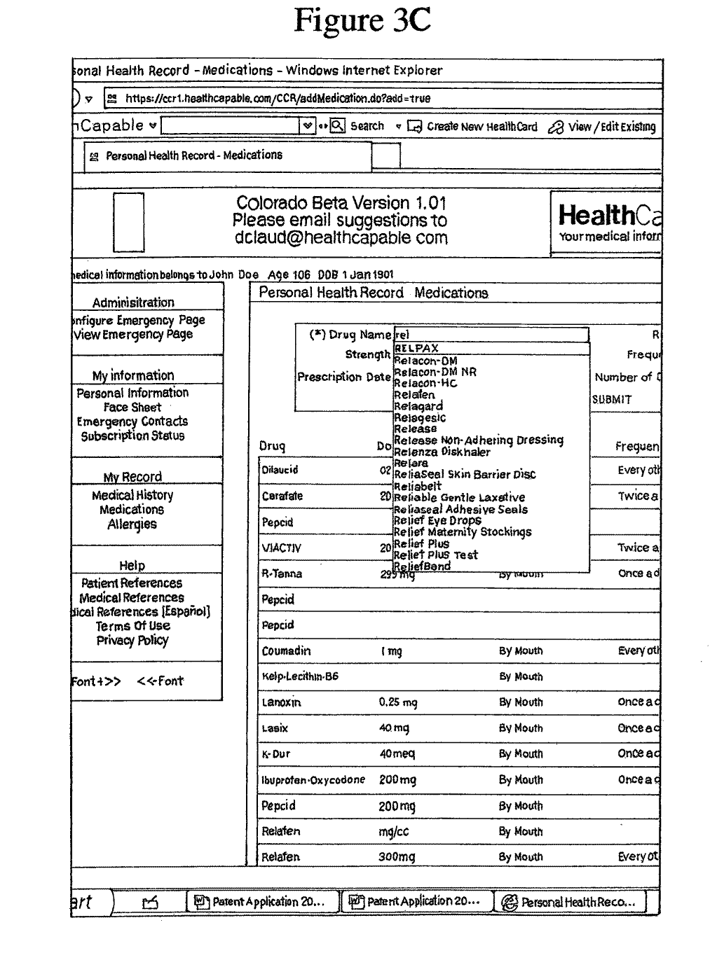

FIG. 4 is a general outline of a health record form input heading;

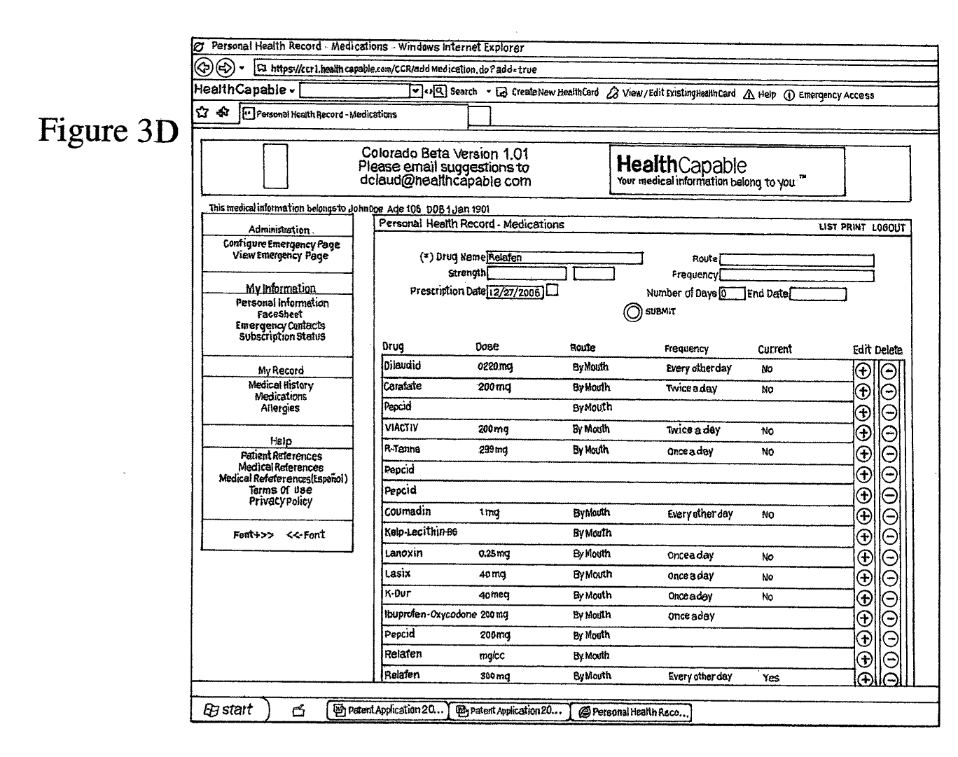

FIG. 5 is a flow diagram illustrating the invention;

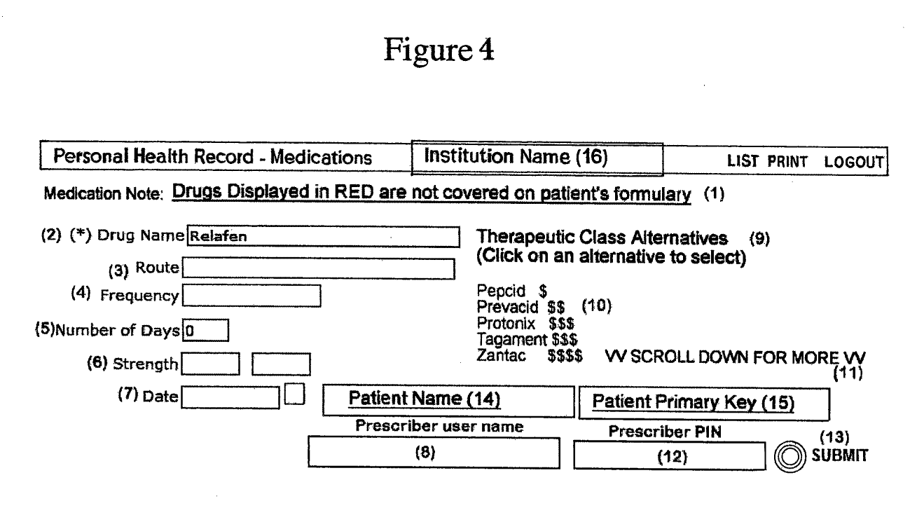

FIG. 6 is a further flow diagram indicating the invention;

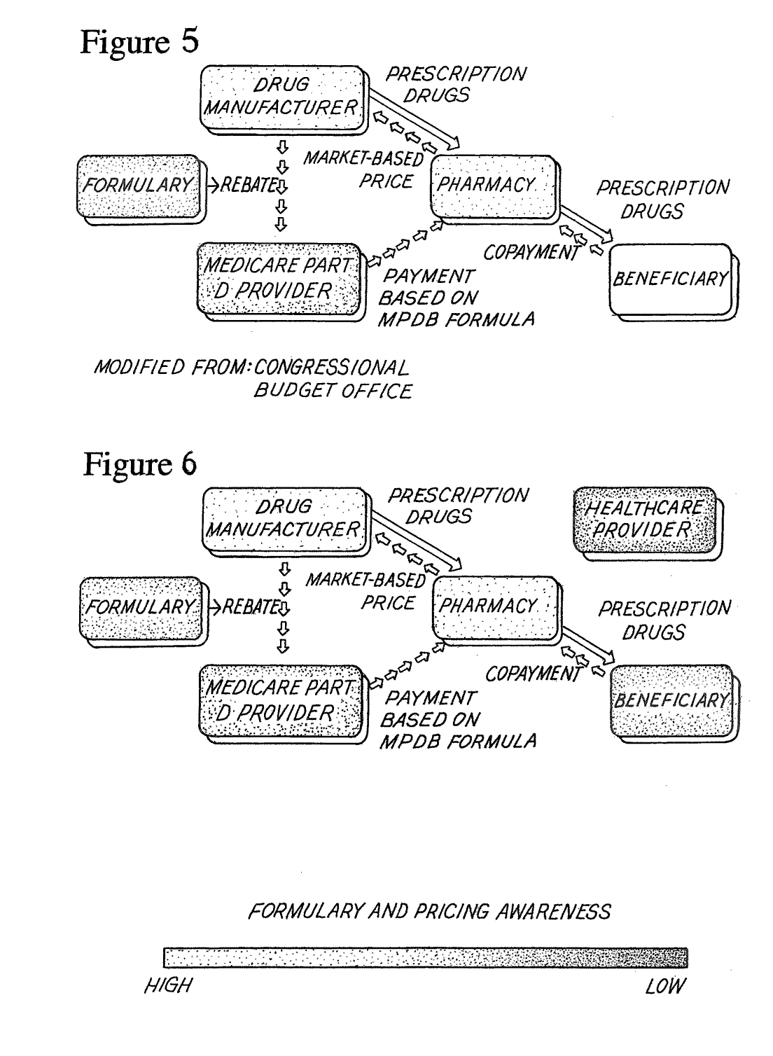

FIG. 7 is a flow diagram illustrating the exchange of health record information;

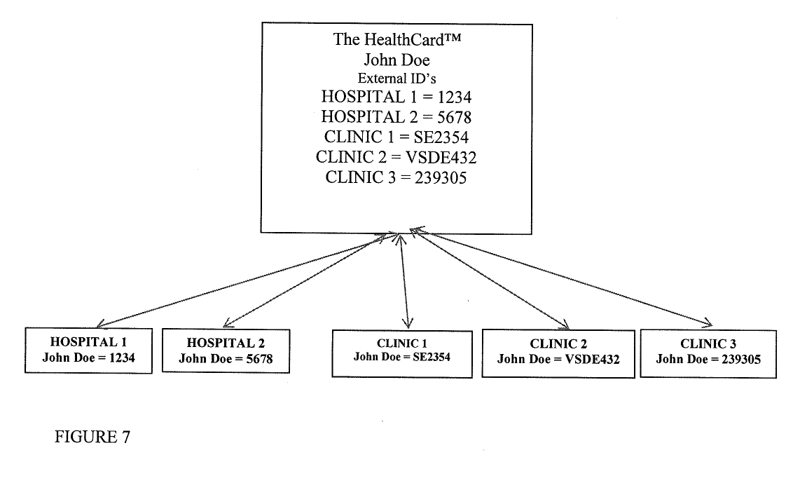

FIG. 8 is a further flow diagram illustrating the transmission of health record information;

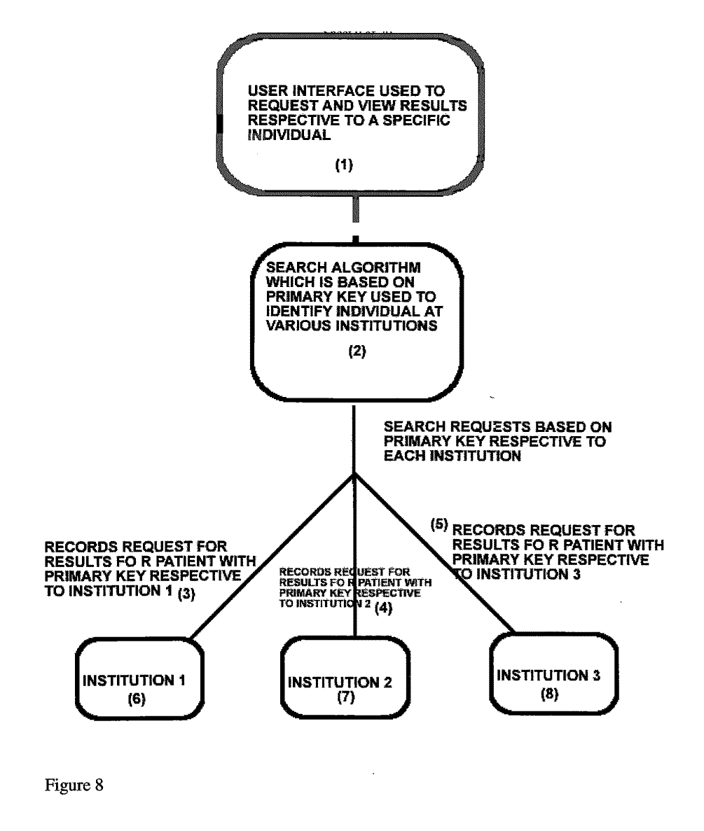

FIG. 9 is an example of a personal health record form;

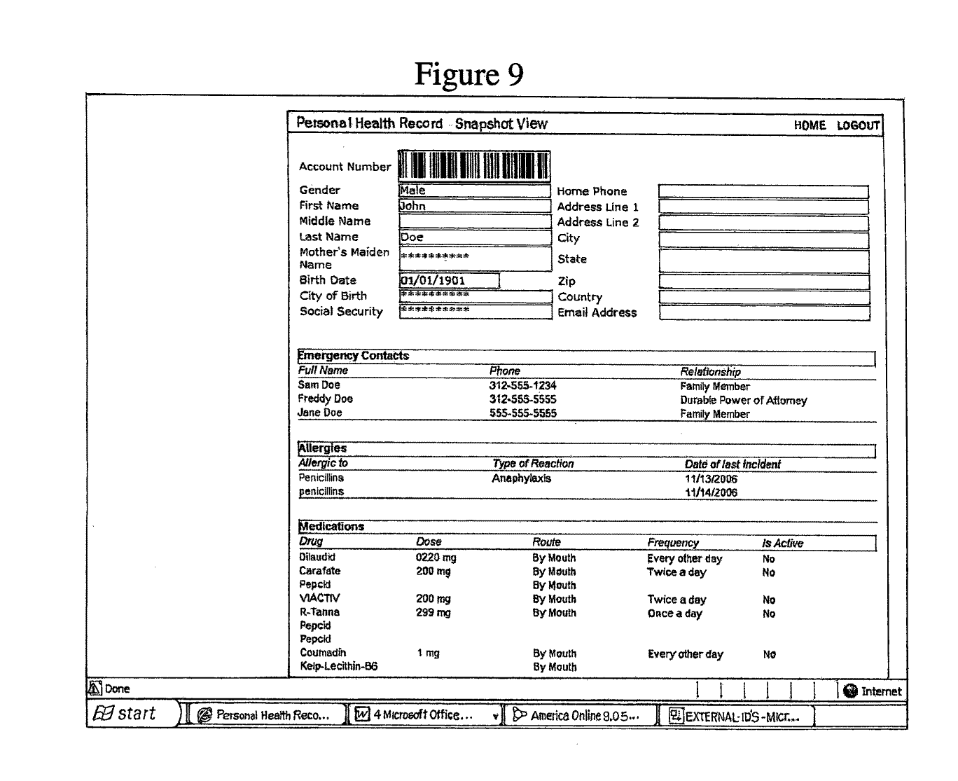

FIG. 10 is an example in a flow diagram of a typical password entry interface;

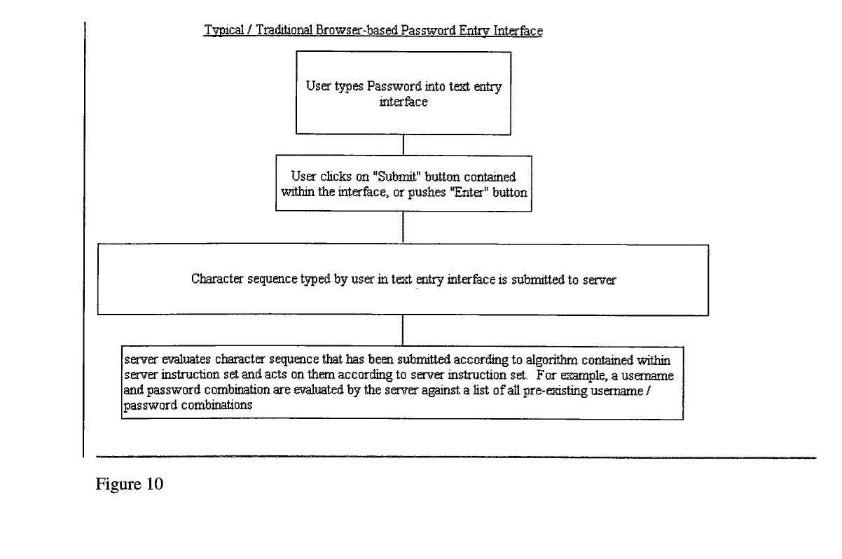

FIG. 11 is similar to FIG. 10 and is a flow diagram of a password entry interface;

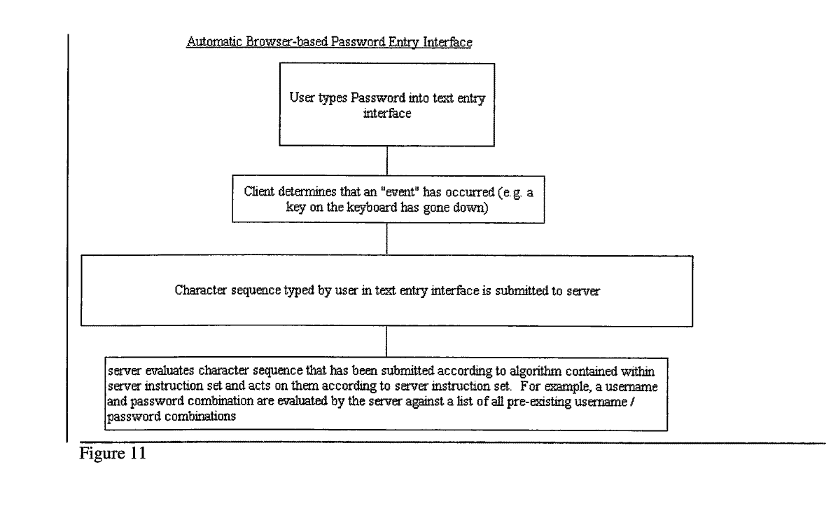

FIG. 12 is a flow diagram illustrating the manner of keeping health records for an individual;

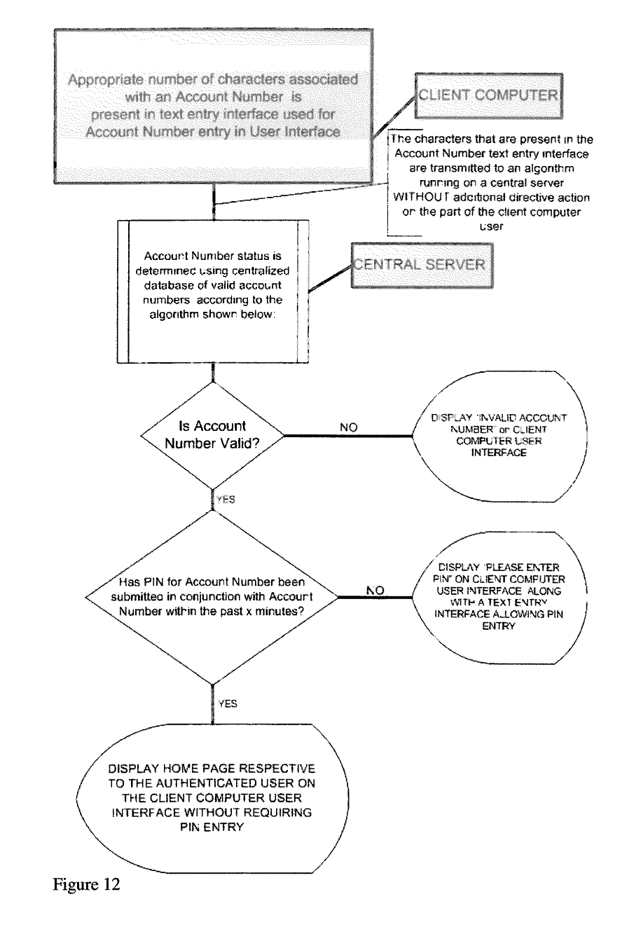

FIG. 13 is a flow diagram further indicating the method for maintaining health records for an individual;

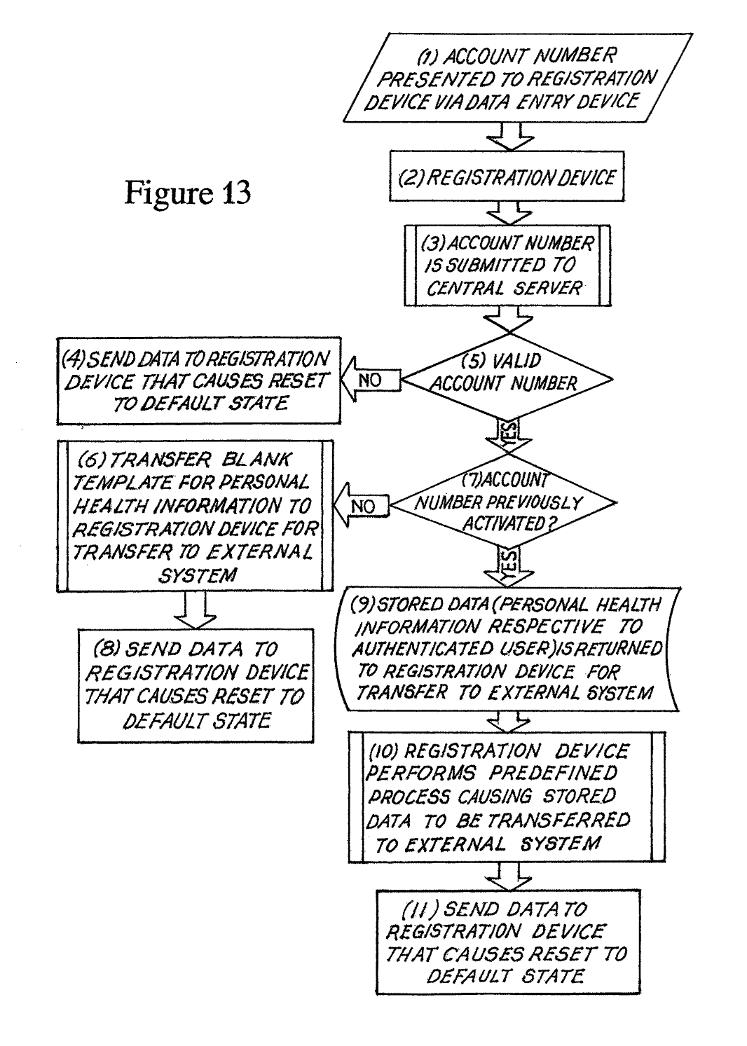

FIG. 14 is another flow diagram similar to FIGS. 12 and 13;

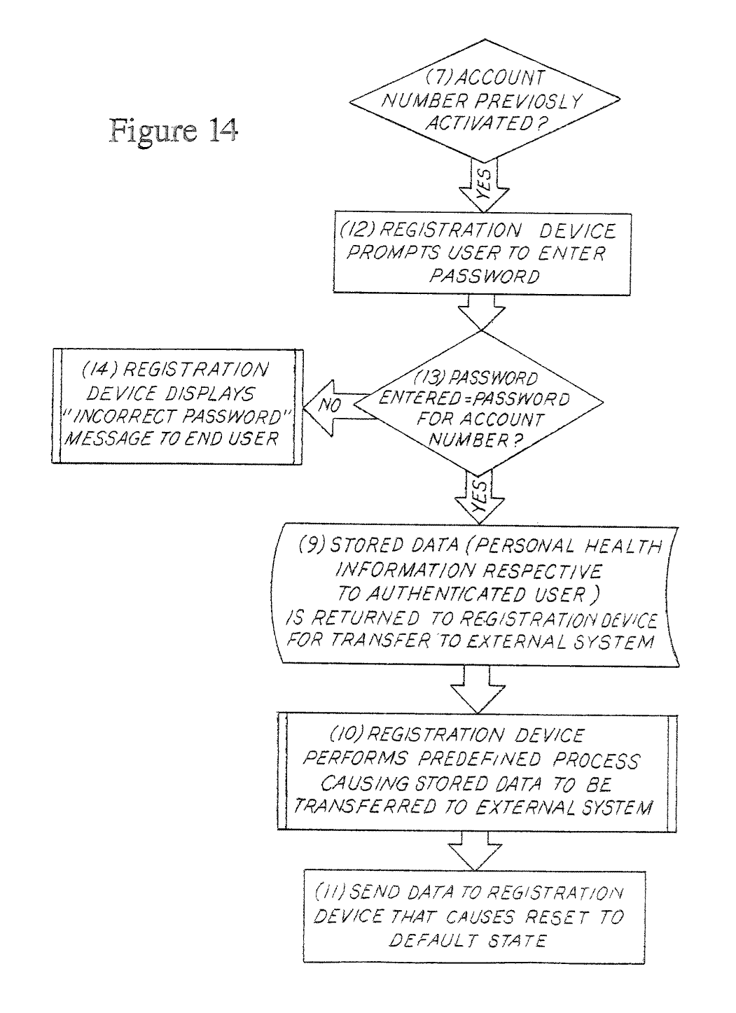

FIG. 15 is another flow diagram illustrating features of maintaining a personal health record system;

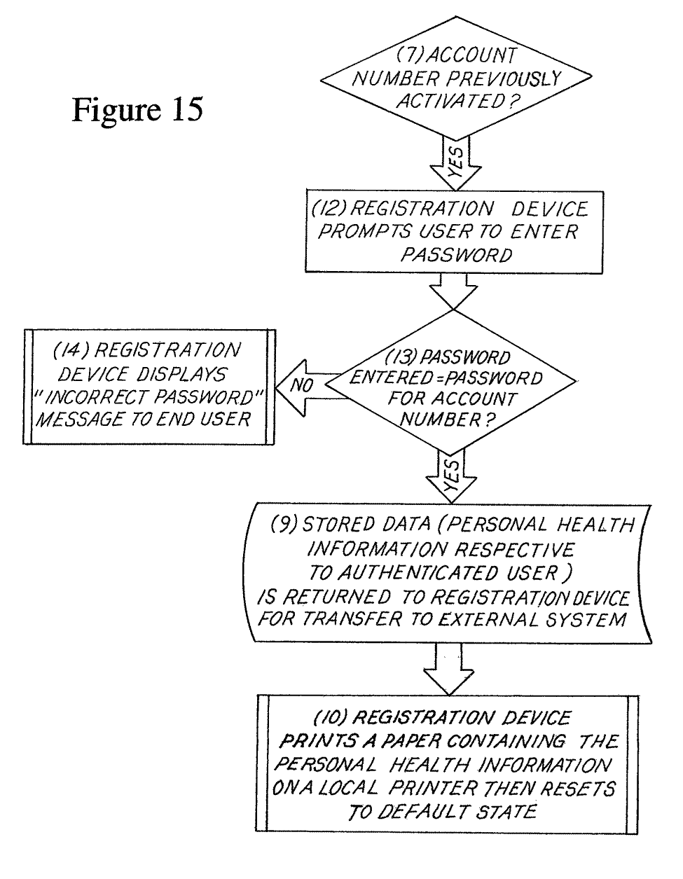

FIG. 16 is a flow diagram illustrating features of the health record maintenance method of the invention;

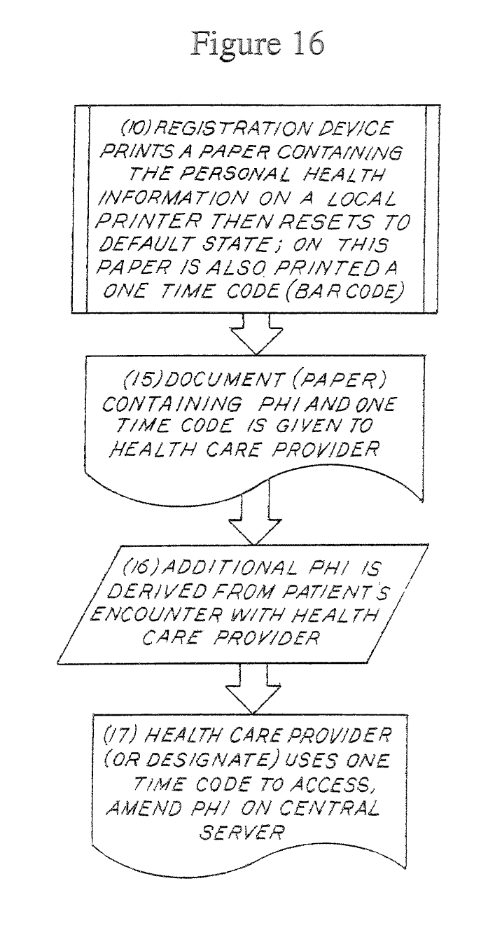

FIG. 17 is a graph illustrating the complexity of record keeping as it affects time;

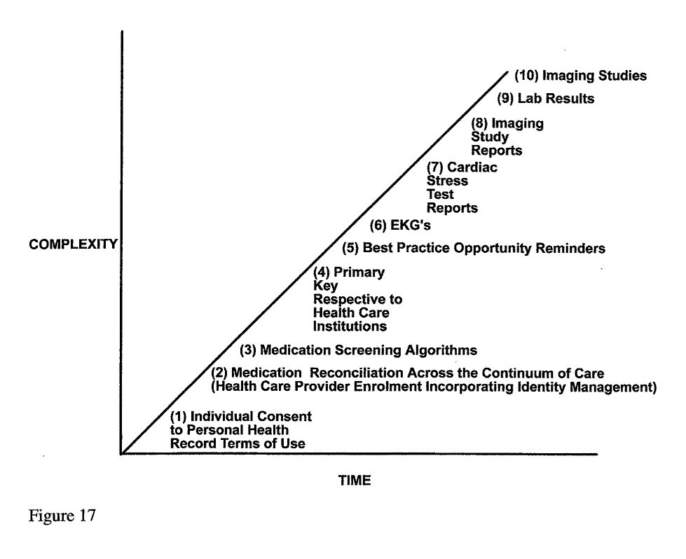

FIG. 18 is a graph similar to FIG. 17;

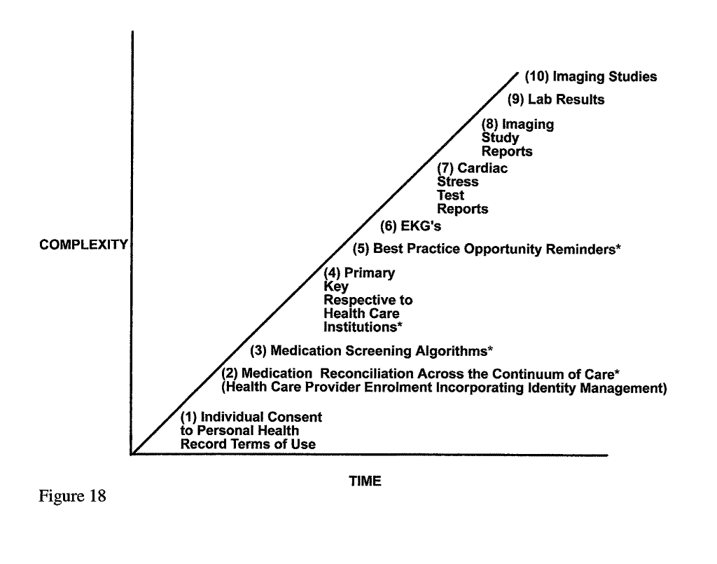

FIG. 19 is a diagrammatic view of am example of the health record keeping system of the invention;

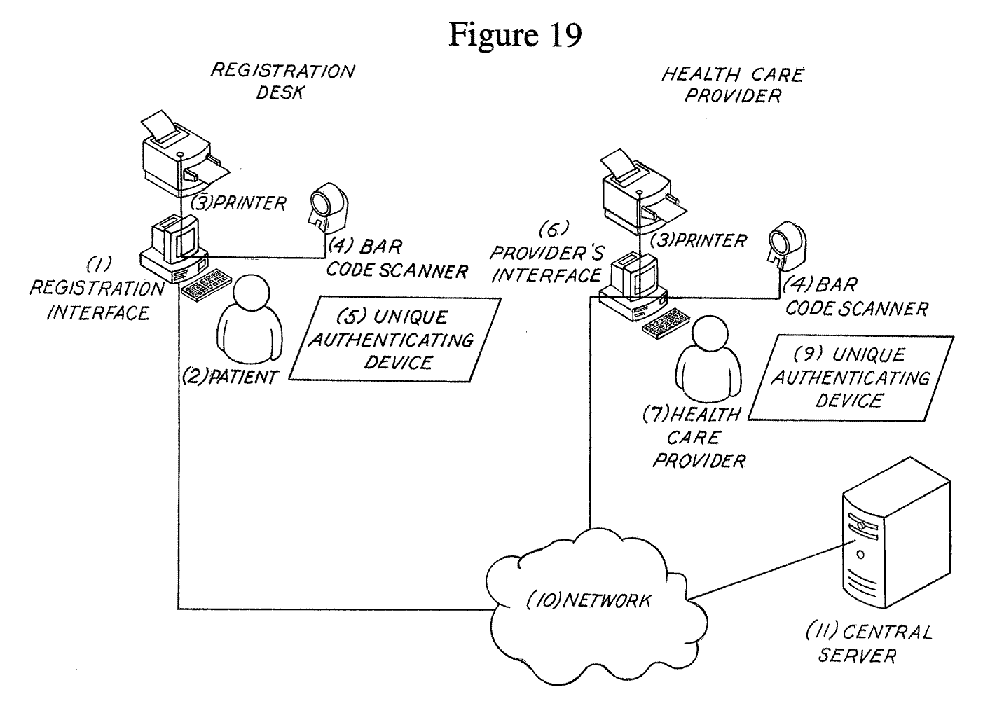

FIG. 20 is a diagrammatic view analogous to FIG. 1 with respect to the health record keeping system of the invention;

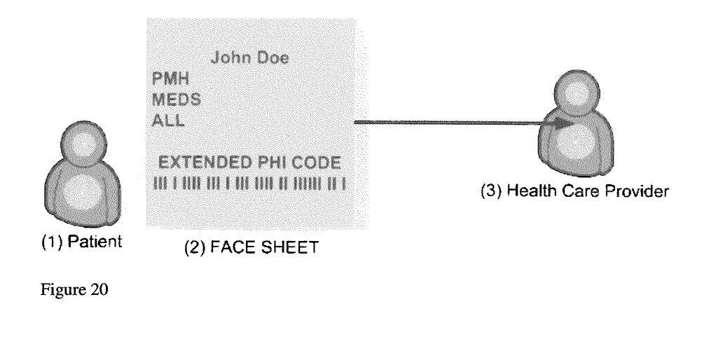

FIG. 21 is a further example of a health record keeping system form;

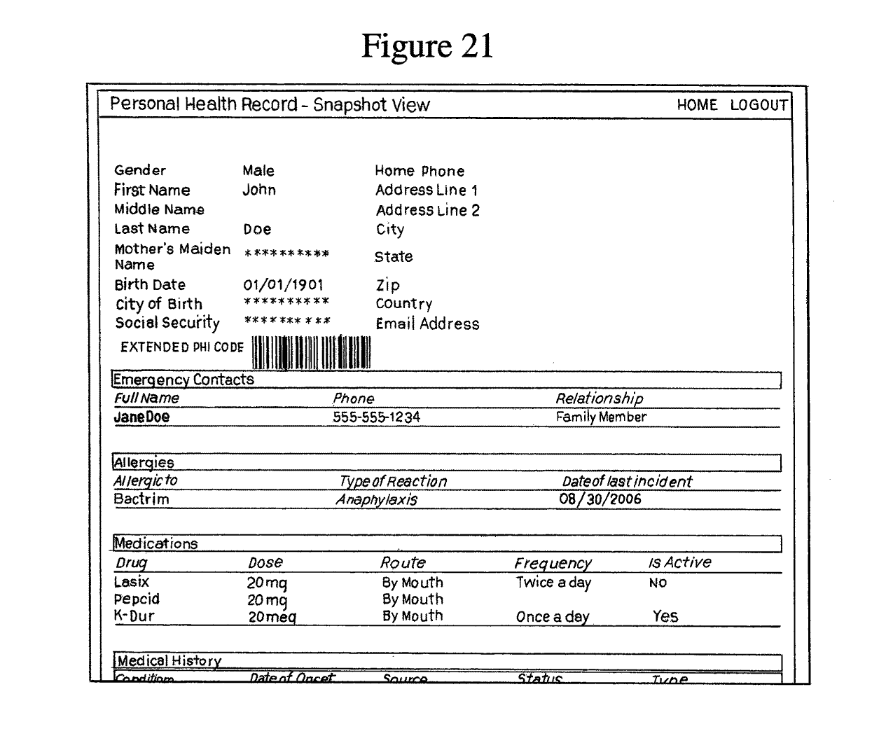

FIG. 22 is a flow diagram of features of the health record care system of the invention;

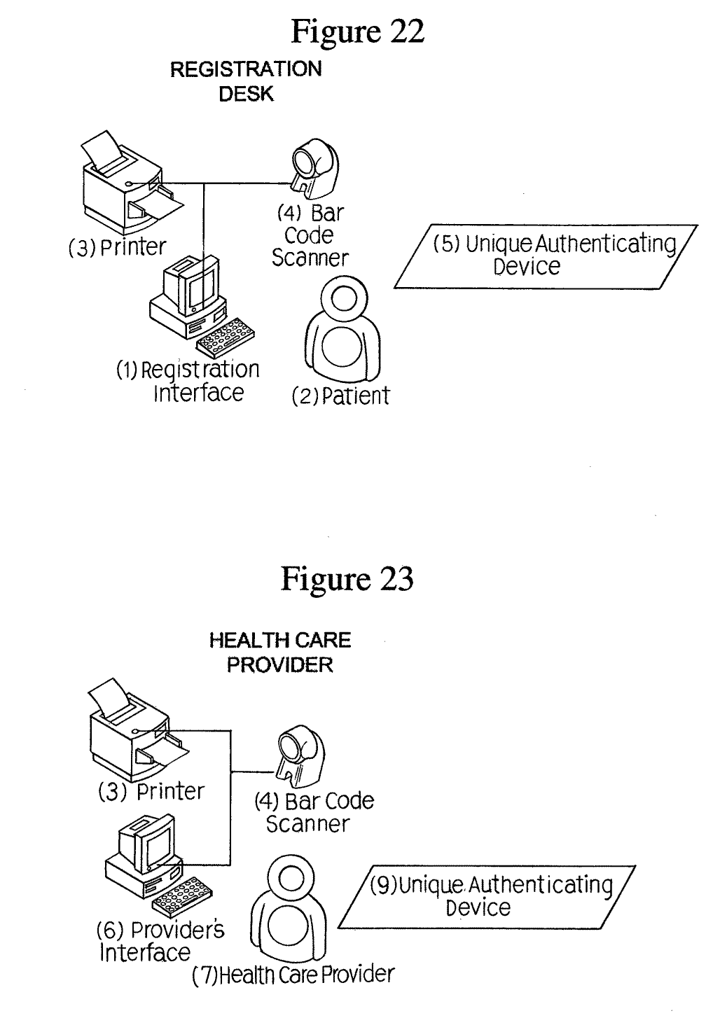

FIG. 23 is a further diagrammatic view of features of the health record keeping system of the invention;

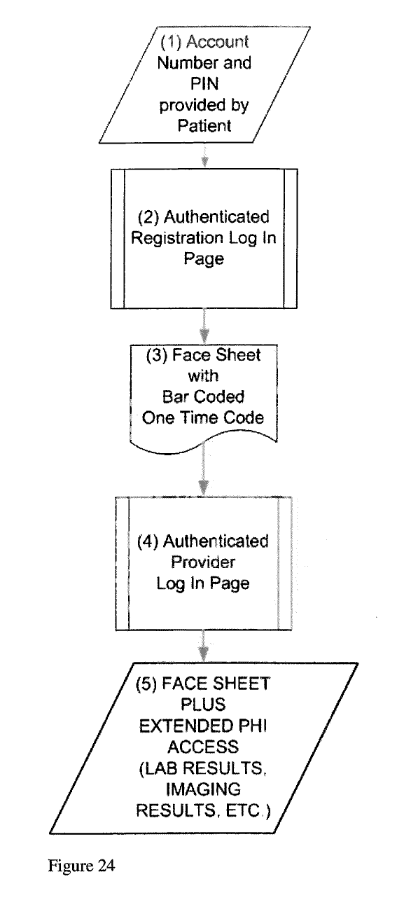

FIG. 24 is a flow diagram illustrating features of the health record keeping system of the invention;

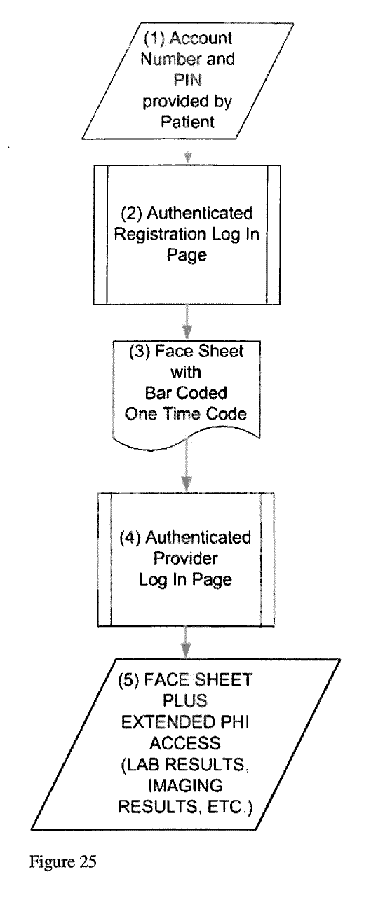

FIG. 25 is a flow diagram similar to FIG. 24 illustrating features of the health record keeping system of the invention;

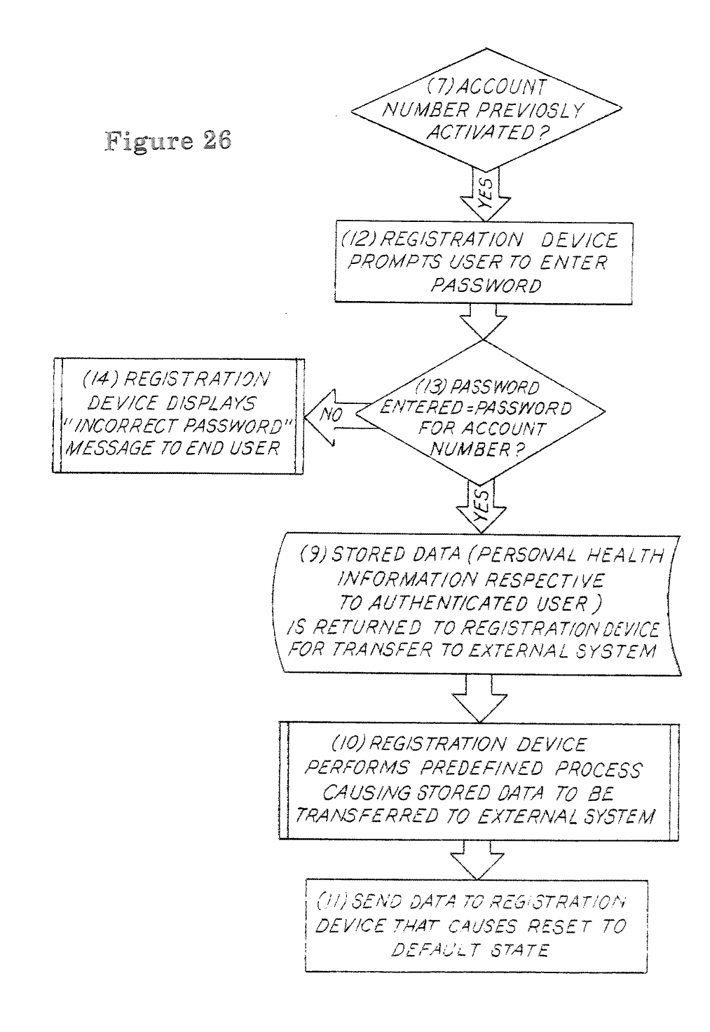

FIG. 26 is a further flow diagram illustrating the method keeping patient health care records in accord with the invention;

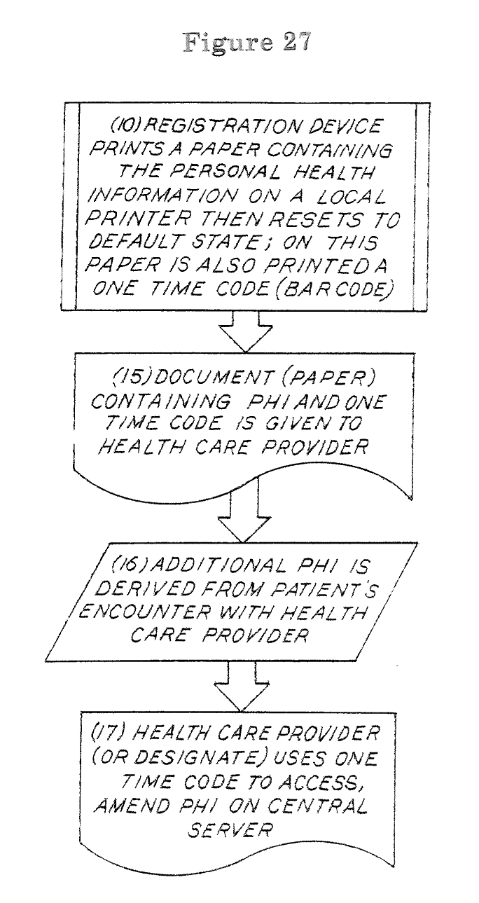

FIG. 27 is a further diagram illustrating aspects of the health record keeping system of the invention as set forth by a flow diagram;

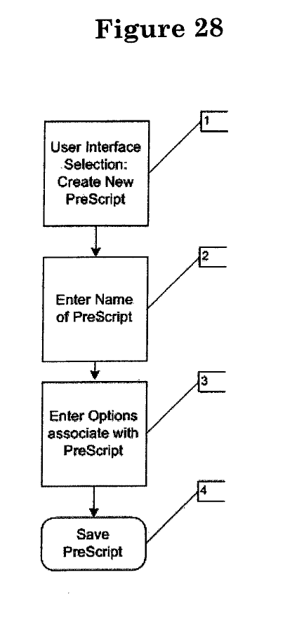

FIG. 28 is another flow diagram illustrating the record keeping system of the invention; and

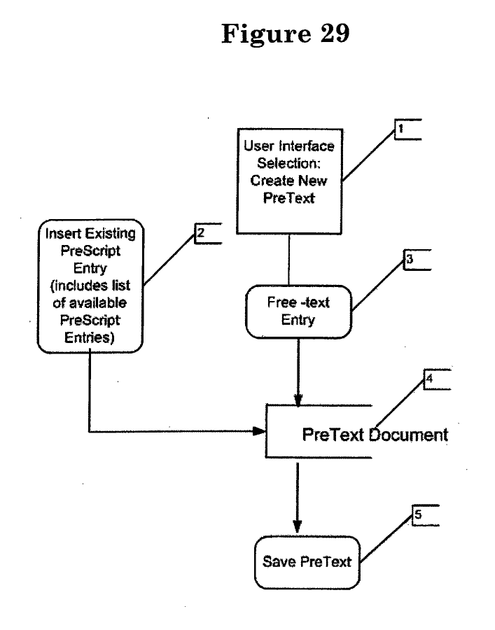

FIG. 29 is a further flow diagram illustrating aspects of the record keeping system of the invention.

### DESCRIPTION OF EMBODIMENTS OF THE INVENTION

FIG. 1 is a depiction of the traditional client-server based architecture associated with the interne. HTTP(s) transport is used to move data over the network between client and server only after distinct directive action on the part of the user.

FIG. 2 is a depiction of the data transport model used by the inventive system. HTTP(s) transport is used to move data over the network between client and server, independently of distinct directive action on the part of the user. It should be clear that we make no claim to have invented this data transport model. The current invention involves novel and unique applications of this data transport model.

FIG. 3 is a depiction of a user interface that implements the data transport model used by the inventive system. Many applications of the data transport model are envisioned and are actually employed in one preferred embodiment of the current invention. Shown in FIG. 3 are the dynamic changes that occur on the user interface in response to user keystrokes.

3 (A) shows the interface after the user has typed an “R” in the text entry interface associated with the medication name.

3 (B) shows the interface after the user has typed “RE” in the text entry interface associated with the medication name.

3 (C) shows the interface after the user has typed “REL” in the text entry interface associated with the medication name. In each case, the drop down list of matching possible choices changes dynamically in response to the keystrokes, without further distinct directive action on the part of the user.

3 (D) shows the interface after the user has selected “Relafen” from the drop down list of possible matching choices. Notable on this screen shot: the color of the Submit Button, and the word “Submit” next to it, has changed from yellow (previous screens) to green. The color of the text entry interface (area that allows the user to type the medication name) has changed from yellow to blue. This has occurred without further directive action on the part of the user, and this occurs in response to directive action on the part of an algorithm running on the central server which evaluates, in real time, the contents of the medication name text entry interface.

FIG. 4 displays additional features according to one preferred embodiment of the current invention. It is representative of the user interface used to enter a medication prescription. Certain elements of the user interface are numbered for descriptive purposes:
a. (1) is a formulary notice that is displayed, in real time, in response to a medication name selected by the user in the text entry interface for medication name (which is associated with the label (2) on this Figure).
b. (2) is the text entry interface for medication name, along with appropriate labeling (e.g. (*) Drug Name).
c. (9) is labeling that indicates the therapeutic class alternatives that are found within the system (in a database stored on the server) corresponding to the drug name selected by the user in (2). Note that the drug names displayed are for illustrative purposes only (these are not true therapeutic class alternatives to Relafen).
d. (10) is a display of therapeutic class alternatives for consideration by the user when considering the medication shown in (2). As shown, price considerations can also be displayed (e.g. the number of “$” signs correspond to the estimated price of the associated prescription), in rank order if desired.
e. (8) and (12) are text entry interfaces designed to authenticate the user electronically.
f. (13) is a dynamic submit button whose color changes with respect to the conformance of the user-entered data with algorithms built into the system (algorithms found on either client, server, or both).

FIG. 5 is illustrative of why price and formulary awareness at the prescribing point is critically important and yet very difficult for the health care provider to master on his own. A multiplicity of Medicare Part D Providers exist. The actual drugs on a formulary—that is, the list of drugs that are preferentially reimbursed by the Medicare Part D Provider—and their respective costs—vary between Medicare Part D Providers as well as between different times. Physicians who lack a system that provides real-time price—formulary awareness at the time of the decision are generally taking a shot in the dark selecting the most appropriate medication when taking into account price and formulary considerations.

FIG. 6 is similar to FIG. 5, but adds an element at the bottom illustrating price and formulary awareness on the part of the various participants in the health care/pharmaceutical industry. Currently, formulary and price awareness, on the part of the patient (beneficiary) and the health care provider is low. One preferred embodiment of the current invention changes this by creating both formulary and price awareness on the part of the health care provider at the time of the prescription decision.

FIG. 7 is illustrative of the system used, according to one preferred embodiment of the current invention, to accumulate the primary keys used to identify a given unique individual within the context of an institution's identity management system. Each institution (Hospital 1, Hospital 2, Clinic 1, Clinic 2, and Clinic 3) has a different primary key—that is, unique character sequence used to symbolize the unique individual within the institution's record-keeping systems. On the patient's first visit to a health care institution, the patient's Personal Health Information, stored on a server according to one preferred embodiment of the inventive system, is amended to incorporate the primary key respective to that health care institution. On all subsequent visits to the same health care institution, the patient is able to provide the same primary key, respective to that health care institution, that was previously used to identify the patient in the institution's respective systems.

FIG. 8 is illustrative of one intended use of the primary keys used to identify the unique individual at each health care institution that provides health care to him. Search algorithms designed to retrieve previously stored personal health information relative to the patient are based on the existing, respective primary keys previously known to be associated with the unique individual.

FIG. 9 is illustrative of a bar code used to provide rapid access to the patient's personal health information once it has been retrieved and printed. The information displayed here includes the bar code which encodes the account number for the patient so that properly credentialed system users can use a bar code reader to instantly enter the account number respective to a unique individual—amending it as their credentials allow.

FIG. 10 illustrates the traditional browser-based password entry interface. Of particular note is the fact that the user is required to click “submit” or push the “Enter” button, as a specific directive action, to cause the characters entered as a password to be submitted, via http(s) transport, to the server for evaluation.

FIG. 11 illustrates the automatic evaluation of user password entries, according to the current invention. Of specific note: the user is not required to click “submit” or push the “Enter” button, as a specific directive action, to cause the characters entered as a password to be submitted, via http(s) transport, to the server for evaluation.

FIG. 12 illustrates the automatic evaluation of the username using a similar system to that shown in FIGS. 10 and 11; however this algorithm envisions a requirement that the user be required to enter a Personal Identification Number (PIN) only once every x number of minutes (where x is determined by a central administrator). In conjunction with system that facilitates the rapid entry of an account number, this system can be used to authorize system users using both something they have (a device that conveys the account number) and something they know (a PIN) only once every x minutes. For a period of x minutes after the user demonstrates that he knows the PIN associated with the account number, the user is not required to re-enter the PIN. A user-controlled algorithm allowing the user to report the loss of the device used to convey the account number would also be an essential part of this inventive system.

FIG. 13 illustrates a process algorithm used to automatically evaluate an account number entered by a user on a client computer using a text entry interface associated with the user interface. Again, without specific directive action on the part of the user, the account number is submitted to the server for evaluation (shown as step (3)). If the account number is valid and previously activated, the Personal Health Information respective to that account number is transmitted, via http(s) transport, to the client computer. The client computer may then take various actions on the information thus received, and then return to the default state (i.e. waiting for the next account number entry).

FIG. 14 is similar to, or a continuation of, FIG. 13; however this algorithm incorporates a required user entry of a password which must match that previously associated with the account number entered in order to accomplish Personal Health Information retrieval.

FIG. 15 is nearly identical to FIG. 14, but the automatic printing of the Personal Health Information retrieved respective to an account number and PIN combination is incorporated into the algorithm. This creates an unattended patient registration desk with more advanced functionality than most attended patient registration desks in health care today.

FIG. 16 illustrates an algorithm that is incorporated into the algorithm shown in FIG. 15. This algorithm incorporates the ability of the patient to grant re-access to his Personal Health Information using the one-time code (e.g. unique character sequence) that is displayed via a bar code on the document which contains the Personal Health Information respective to the patient. The rules associated with use of the one-time code—e.g. how many times it works, the length of time it is valid, the roles of valid users of the code, etc. are all determined by algorithms incorporated into the central server.

FIG. 17 illustrates one preferred embodiment of the incremental approach to the creation of a community-wide health information infrastructure according to one preferred embodiment of the current invention. The approach recognizes and incorporates a hierarchy of categories of medical information, which are sub-categories of the entire body of Personal Health Information. The approach is predicated on the principle that enthusiastic physician participation is a fundamental requirement for successful implementation of the more complex elements of the system. As the system involves the voluntary participation of multiple health care providers, the approach is designed to gradually build trust in the system. Further description of the incremental elements is below:

(1) Individual consent to Personal Health Record Terms of Use—the patient owns the data and must consent to its management by an outside entity.

(2) Medication reconciliation across the continuum of care—a variety of studies have identified the dangers associated with the lack of a master medication list that goes with the patient from provider to provider. Multiple opportunities for safer, more efficient health care are derived from this element, as described within this application. This category creates a system that, once present across a community, is ideally extended into electronic prescribing with associated safe prescribing tools.

(3) Medication screening algorithms generally refers to the use of computerized algorithms to screen for drug-allergy interactions, drug- drug-drug interactions, drug-disease interactions, and the like. It may also refer to improving price-formulary awareness on the part of the physician at the time the prescription is written. Price-formulary awareness on the part of the physician at the time the prescription is written has been demonstrated to save at least 3% of the total cost of prescription drugs. This creates the clearly sustainable business model for the inventive system.

(4) Health care institutions and other entities involved with the health care industry have various appellations for the primary key used in their respective systems to identify an unique individual. For this description of this approach, “Primary key respective to health care institutions” refers to the ability of the inventive system to store and retrieve the “medical record number” or “unit number” or “chart number” respective to the unique individual at each of the institutions he or she visits to obtain health care.

(5) Best Practice Opportunity Reminders refers to the use of the inventive system to create an awareness on the part of health care providers of recommended best practices associated with the care of individuals, customized based on the (machine readable, machine interpretable) personal health information contained in the system.

(6) EKG″s refers to electrocardiogram storage and retrieval respective to the unique individual

(7) Cardiac stress test reports refers to the storage and retrieval of cardiac stress test reports.

(8) Imaging study reports refers to the storage and retrieval of imaging study reports (e.g. radiologist Xray interpretations).

(9) Lab results refers to the storage and retrieval of lab results.

(10) Imaging studies refers to the storage and retrieval of imaging studies, e.g.

xrays.

FIG. 18 is representative of the incremental approach to the creation of a community-wide personal health information infrastructure, according to one preferred embodiment of the current invention. It illustrates the general concept that patient consent, and medication reconciliation across the continuum of care create a platform derived from clinical data (i.e. data derived directly from health care providers) that is useful for the creation of a much more complex system. Elements of the current invention make this approach feasible; using all known systems currently in existence this approach would not be feasible.

FIG. 19 represents an overview description of the central physical elements of one element of one preferred embodiment of the current invention. Each element is further described:

1) Registration Interface describes the user interface—a web page running on a web browser that is designed to be used by either the patient or an administrative assistant, to register the presence of a specific patient and to retrieve PHI respective to that patient, if available. In another preferred embodiment of this interface, this web page is password protected.

2) Patient is representative of the patient using the system

3) Printer is representative of a printer that is used to print, on paper, documents sent to it from the computer that is running the Registration Interface

4) Bar code scanner is representative of a bar code scanner used to enter a sequence of characters into the Registration Interface—such sequence of characters are encoded in a bar code that the patient or other user presents to the bar code scanner

5) Unique Authenticating Device represents a device used to convey a user name to the Registration Interface—such user name being unique within the system and respective to a specific patient—in this example the unique authenticating device could be a paper with the patient's user name encoded as a bar code

6) Provider's Interface describes the user interface—a web page running on a web browser that is designed to be used by either the physician or a physician assistant to retrieve and/or modify PHI respective to a specific patient. IN another preferred embodiment, this page is password protected.

7) Health Care Provider—representative of a physician, nurse, physician assistant, or nurse practitioner.

8) Not shown

9) Unique Authenticating Device represents a device used to convey a user name to the Registration Interface—such user name being unique within the system and respective to a specific patient—in this example the unique authenticating device could be a paper with the patient's user name encoded as a bar code

10) Network represents a virtual or physical link connecting all of the involved computers

11) Central Server represents a computer acting as the computer that runs the application and which stores the PHI in a database.

To further describe the preferred embodiment of the element shown in FIG. 19:

The patient (2) arrives at a registration desk and presents his account number, which appears as a bar code, to the bar code scanner (4); the bar code scanner (4) conveys the account number to the registration interface (1). The registration interface (1) has been designed to convey the number so entered to the central server (11) over the network (10). The application running on the central server (11) compares the account number entered by the patient; if the account number corresponds to a valid account number within the system, the basic PHI associated with that account number is conveyed over the network (10) back to the registration interface for display and printing on a document called a “Face Sheet.” Specifically included on the Face Sheet is a one-time code that can be used by the health care provider to retrieve extended PHI—by submitting the one-time time code to the central server (11) through the Provider's Interface (6), which is password protected to prevent unauthorized information access.

The one-time code may have various characteristics; it is a one-time code in that a given character sequence is only issued once in the lifetime of the system; the system may also be designed to restrict use of the code to a single instance the system may also be designed to disallow access to PHI after a given time period.

FIG. 20 is illustrative of the process, according to one preferred embodiment of the invention, by which a Face Sheet (2), once generated by the patient (1), is handed to the health care provider (3). The patient is thus able to convey to the health care provider the ability to retrieve Extended PHI in a secure manner. This is representative of one preferred embodiment; another preferred embodiment allows this process to occur electronically (e.g. the one-time code is conveyed to the health care provider in the context of a different application, e.g. an electronic medical record, an email, etc).

FIG. 21 is illustrative of the Face Sheet, according to one preferred embodiment of this element of the invention.

FIG. 22 is illustrative of the Registration Desk used by a health care provider.

This figure is used to further illustrate the process by which the patient authenticates himself—the Unique Authenticating Device (5) may be any device that can convey a series of characters that has been uniquely associated with the patient to the Registration Interface. Envisioned devices include magnetic stripes, RFID's, bar codes, and keyboards/keypads. According to one preferred embodiment of the current invention, all of the account numbers used to identify patients have an identical number of characters (16). This system design allows the Registration Interface to automatically submit any 16 digit sequence of characters entered into the Interface for evaluation by the algorithm running on the central server; the Registration Interface causes 16 digits entered by the patient to be evaluated without further specific directive action on the part of the user (no need to click the submit button).

According to another preferred embodiment of the invention, the Registration Interface is password protected—that is, only authorized users within the system are allowed to run a Registration Interface. This helps restrict the unauthorized retrieval of PHI—only authorized system users are allowed to retrieve basic PHI using account number only (no password required). Also this facilitates auditing for attempted unauthorized retrieval of PHI as the actions of individual users can be monitored.

FIG. 23 is further illustrative of the system from the health care provider's (7) point of view. The health care provider uses a provider's interface (6), which may be password protected to prevent unauthorized access, to retrieve extended PHI using the one-time code provided by the patient. This one-time code may be presented by the provider to the registration interface via a bar code scanner that conveys the one-time code to the registration interface. Unique Authenticating Device (9) may represent a device to convey the unique characters that identify the health care provider within the system.

FIG. 24 is a flow sheet diagram illustrating, in an overview, the sequence of events that occurs in the health care environment, according to one preferred embodiment of the current invention. The patient enters an account number and PIN into an authenticated registration log in page (2); authenticated means it is password protected from unauthorized usage. The registration interface associated with (2) causes a face sheet (3) to be printed automatically—without further specific directive action on the part of the user. Included on the face sheet (3) is a bar coded one-time code which conveys the ability to retrieve specific information within the system, using the health care provider's interface (4), called an authenticated provider log in page. Again, authenticated means it is password protected from unauthorized usage. Using the authenticated provider log in page (4), the health care provider submits the one-time code to the central server; in response to a valid one-time code, the central server causes both basic and extended PHI to be transmitted to the health care provider interface for appropriate display and/or printing.

FIG. 25 is similar to FIG. 24 but displays slightly more detail. The account number (1) is presented to the Registration Device (2) (the device on which the authenticated registration log in page, (2) from FIG. 24, is running). The account number so entered is submitted, over a network to a central server (in step 3) for evaluation according to an algorithm running on the central server. If the account number is found to be valid (step 5), and previously activated by a user (step 7), then PHI is returned to the registration device for display and/or printing and/or electronic transfer to another application. If the account number is found to be valid (step 5) but the account number has not been previously activated (step 7), then a blank template is transmitted to the registration device for completion by the patient, by the health care provider, or both in collaboration. This blank template (6), when completed, can be used to enter PHI into the system using the account number newly provided to the patient.

The registration device, by various means, can be caused to return to the default state in which it displays the element of the registration interface which is designed for the submission of account numbers, e.g. step (1).

FIG. 26 is again illustrative of some additional details or variations that are associated with the registration interface, according to the current invention. In this embodiment, if a previously activated account number is entered (7, corresponds to (7) in FIG. 25), the registration device prompts the user to enter a password. This password, along with the account number previously entered, is then conveyed to the central server via a network for evaluation (step 13); if the account number and password match a known combination of same, the stored data respective to that combination is conveyed to the registration device for transfer to an external system (step 10), and the registration device then again returns to a default state in which the interface is designed to allow the user to submit an account number.

FIG. 27 describes one preferred embodiment of the current invention; step (10) corresponds to step 10 in FIG. 26, however the transfer of PHI (and the one-time code) occurs through a printer attached to the registration device which is caused to print the face sheet along with the one-time code; the one-time code is printed on the face sheet in a bar coded manner. This face sheet is then given to the health care provider (step 15); the patient/provider encounter occurs (step 16), generating additional PHI; the health care provider or his/her designate uses the one-time code which is bar coded on the face sheet to gain immediate access to the PHI that is stored on the central server; such PHI can then be both viewed and/or amended.

FIG. 28 is a block diagram that describes the creation of a PreScript. In essence, a PreScript is a defined list of possible choices suitable for insertion at a given point within a string of text. The diagram is further described:

(1) The user selects an option on the user interface which is designed to create a new PreScript.

(2) The user is required to enter a name for the PreScript

(3) The user is required to enter the options that will be associated with the PreScript. In essence this is the creation of the list of possible options associated with the Prescript. In one preferred embodiment of the invention, rather than manually enter all of the possible entries on this list, the user is allowed to electronically indicate a database containing the list of possible entries. As an example, the user could either manually type in some choices (e.g. Right, Left) or could indicate the location of a database containing the names of all acceptable medication choices.

(4) The user saves the PreScript for future use.

FIG. 29 is a block diagram that describes the creation of a PreText document.

(1) the user selects an option allowing the creation of a new PreText document.

(2) the user is allowed to insert a PreScript (e.g. constrained list of choices) into the PreText document.

(3) the user is allowed to type whatever character sequence he prefers

(4) is representative of the PreText itself, contained within a text entry interface (or similar) in an instance of a browser

(5) indicates the user's ability to save the PreText, perhaps giving it a name in the process. According to the preferred embodiment of the current invention, the file would generally be saved on the central server for future use by system users.

In the following description, various terms will be utilized in their normal sense and context and will include the following additional features with respect thereto:

“PreScript” means data entry elements which allow the end-user to select only from a constrained list of defined entries; e.g. the end-user can select from a predefined list of choices. Previous provisional patent applications that we have filed demonstrate the novel and unique way in which we use PreScript to create a user interface that displays a complex information set with inherent interdependencies, in a novel and unique way that creates real-time interactivity in response to user actions such as individual keystrokes, in the context of a user interface which may be accessed by anyone in the world who has a connection to the internet and a browser designed to view information derived from the internet. PreScript could also be thought of as autocomplete selections that effectively create drop-down choices for various elements of a template. These drop-down choices—that is, the entire set of possible choices available to the end-user—may be limited by a central administrator to a given constrained list, or may be modified or selected by the author of the Pre-Text (defined below) of which the PreScript is a part.

“PreText” means sentences, paragraphs, or pages of information, generally textual but sometimes numeric in nature, presented in a browser-based text entry interface that constitutes a pre-defined template used for form creation and submission. Included in these forms are two types of variable data:
a. highly constrained data entry options (“PreScript™,” defined above) and
b. poorly or unconstrained data entry options (e.g. free-text).

“User” will mean an individual who desires to have access to the data contained in a database, whether to view it only or to view and change it.

“Screen” means the visual presentation at a terminal setting forth and representing information visually to the user. The screen may include tool bars and other information, instructions, and the like which will facilitate use of the information provided to or by the user as well as interactions by or for the user through the terminal to a server.

“Unique identifying number” means a character sequence which has been uniquely assigned to a specific user—utilizing an association assigned by the system upon first use of the system by that user. This is also called the “primary key” in the context of this application.

“Unique Authentication Device” (UAD) means a device that can store and convey a number that is uniquely associated with the device, whether digitally via a direct connection, via radio frequency emissions, or via other means of conveying digital characters.

“Client” means a user's computer, as distinguished from a central server to which it may be connected over a network.

“Central Server” means a computer which is connected to a network, and which is used as a central repository for the storage and retrieval of electronic information. A central server also runs applications, generally written in machine-interpretable code, which define the ways the central server will interact with information submitted to it over a network.

“Network” means any means of electronic data transfer communication between servers, terminals and hardware including the World Wide Web, wireless and wired internal dedicated networks and external networks.

“Password” means a character sequence which is meant to be known to a specific user and generally not known by others.

“External ID” will mean a unique identifying number used by individuals or other entities in the health care industry, such as hospitals, clinics, and third-party payers, and other entities to designate a unique individual within their respective system that is stored in the inventive system.

“Focus” means the current window, menu, text entry interface, or dialog box that is affected by a key stroke or mouse movement.

“Stateful Submit Button” is a defined area of a user interface that is used to dynamically convey information in response to user actions in real time. The dynamic display may take the form of different colors, different characters, or other various possibilities. Clicking on the stateful submit button causes software-defined actions to occur, e.g. an interaction between the client and the server. Causing the cursor to hover over the stateful submit button will also cause software-defined actions to occur.

“Master Patient Index” will be used to designate the list of unique individuals whose information is stored by a given institution; frequently the name of each individual is paired with a primary key.

“Primary Key” will be used to designate the character sequence used within a master patient index in association with a unique individual's identifying information. One example of a primary key, albeit not perfect, in general use is the social security number which is used by the social security administration to associate a number with a unique individual.

“Text Entry Interface” is used to represent an area of a computer user interface that is used to display characters typed by the user; in our current preferred embodiment this is in the context of a browser window on a client computer.

“PreScript” is used to represent a text entry interface on a client computer, typically a browser, in conjunction with an element that creates the real time display of information that is context sensitive and responsive to user computer actions, e.g. keystrokes, without further directive action on the part of the user (e.g. no mouse-click required). In some embodiments of PreScript, the character sequence displayed in the text entry interface can be changed without additional keystrokes on the part of the user—either by specific directive action on the part of the user (e.g. clicking on a choice displayed in the context-sensitive display) or without specific directive action on the part of the user (e.g. there is only one choice left in a list of possible matches with the character sequence the user has typed into the text entry interface). Prescript, in a preferred embodiment according to the current invention, is used to constrain user entries to those that are found in a specified medical vocabulary.

The central elements of one preferred embodiment of the current invention are: a client computer, a user interface running on the client computer, a central server which is a computer, a network that connects the central server to the client computer, and computer programs running on the central server which control many aspects of the behavior of the user interface running on the client computer.

Other essential elements of one preferred embodiment of the current invention are: an identity management system that assigns a primary key to each unique individual who uses the system; a database that includes the names medications as well as various information (e.g. price) respective to each medication; a system of storing information respective to a unique individual through reference to the primary key.

In one preferred embodiment of the current invention, a user “logs on” to the system using appropriate credentials, e.g. account number and personal identification number (PIN). The user views the user interface on the client computer. The user interface allows the retrieval and possible amendment of personal health information relative to one, or more than one, individual (depending on the role of the user).

Using one aspect of the preferred embodiment of the current invention, the user is able to add to the medication list of a patient, taking into account the medications that the patient is currently taking, the price of the medication selected relative to the price of possible acceptable alternatives, the formulary status of the medication selected, the possibility of a drug-allergy interaction, a drug-drug interaction, or a drug-disease interaction. The preferred embodiment of the current invention creates a real-time awareness of these (and potentially other) factors in a manner not possible with other current systems.

Another aspect of the preferred embodiment of the current invention involves the storage and retrieval of the primary keys used by various health care entities to administratively identify a unique individual within their record-keeping systems whether paper-based or electronic. This allows the patient to convey at the time of patient registration his respective primary key for the specific institution he is a a patient of. This also allows for vastly improved ease of identity management when retrieving, from an external source system (e.g. a hospital) additional medical records, e.g. lab results, for a patient from an electronic system—e.g. rather than probabilistic matching of identities based on last name, first name matches, the search algorithm can retrieve all results associated with a given primary key within a system and merely confirm that the last name and date of birth match in both the inventive system and the source system.

The ability of the current invention to create machine readable, machine interpretable data, and specifically medical data, in a user friendly manner, creates feasibilities where there previously was none. Specifically, best practice reminders, customized to the specific needs of an individual patient, can be integrated as one element of the preferred embodiment. The specific needs of the individual patient are determined using an algorithm that incorporates the personal health information that is machine readable and contained within the inventive system.

The use of this system to control the flow of information between various data sources not related to healthcare is also anticipated and incorporated into this application by reference. Without doubt, many industries would benefit from “clean data,” that is, data that complies with a standardized vocabulary which allows for context-sensitive, perhaps interactive, systems.

The foregoing has outlined, in general, the physical aspects of the invention and is to serve as an aid to better understanding the more complete detailed description which is to follow. In reference to such, there is to be a clear understanding that the present invention is not limited to the method or detail of construction, fabrication, material, or application of use described and illustrated herein. Any other variation of fabrication, use, or application should be considered apparent as an alternative embodiment of the present invention.

What is claimed is:

1. A method for maintaining personal, integrated medical records for each member of a class of individuals comprising the steps of:
(a) providing and programming a computer system for identification of a hierarchy of categories of medical information provided through a network from at least two independent sources, said medical information categories capable of association with single individuals in said class, said hierarchy determined by at least the source of said information and in accord with a program of said system, at least some of said sources being independent from the other and each source having a characteristic quality of complexity in said hierarchy;
(b) collecting said categories of medical information via said network by an electronic storage facility, said medical information for at least two of said categories for at least two single individuals in said class to provide a unique collection of medical information for each said single individual;
(c) storing the unique collection of said collected information for said categories for each said single individual in said electronic storage facility;
(d) periodically updating the unique collection of said collected information for each said single individual via said network in said electronic storage facility in each category for each said single individual by an internet connection;
(e) providing secure access to the entirety of said collected and stored unique collection of collected information in said storage facility via said network and a computer system programmed condition for each said single individual, by said each single individual only; and
(f) providing permitted access by internet connection via said network to part of said categories of said unique collection of collected information by at least one entity other than the said each said single individual in accord, at least in part, with said hierarchy of categories of medical information in accord with a further computer programmed condition wherein the part of said hierarchy of categories accessible is dependent upon the identity of said one entity by a programmed security protocol made available for permitted access to said at least one entity other than said single individual.

2. The method of claim 1 wherein the hierarchy of categories includes two or more of the following:
(a) drug prescription history of said individual;
(b) laboratory test results of said individual;
(c) diagnostic physician reports of said individual;
(d) hospital records of said individual;
(e) insurance claim records of said individual;
(f) clinical records of said individual; and
(g) nursing home records of said individual.

3. The method of claim 2 wherein collecting the medical information is carried out at least in part through the Internet.

4. The method of claim 1 wherein providing secure access to the medical information of said individual is effected by a unique keycard for said individual.

5. The method of claim 3 wherein providing permitted access includes providing an emergency means for accessing the medical information of said individual independently from said unique keycard.

6. The method of claim 1 wherein providing permitted access includes providing an emergency means for accessing at least some of the medical information of said individual independently from the step of providing secure access by said individual.

7. The method of claim 2 wherein the medical information is accessed through an electronic network.

8. The method of claim 1 wherein said hierarchy of categories includes a compendium of pharmaceutical compounds retained in said storage facility, and further including a method of searching for pharmaceutical compounds by said computer system for use in generating a prescription, comprising the steps of:
(a) displaying a text entry interface having a first field on a screen of a display device;
(b) receiving an input of a first character in the first field of the text entry interface on said display device;
(c) providing the first character to a remote server via a network;
(d) receiving a set of pharmaceutical compounds that are possible matches to the first character from the remote server via the network in substantially real time;
(e) displaying at least a portion of the set of pharmaceutical compounds in a static data set display area on the screen of said display device;
(f) updating the display of pharmaceutical compounds on said display device in response to an input of a second character via the network, the updating being provided in substantially real time; and
(g) identifying at least one of the pharmaceutical compounds on the display device.

9. The method of claim 8, further comprising:
(h) displaying the selection of the one of the possible matches in the first field.

10. The method of claim 1 wherein storing said collected information comprises the steps of storing said information in a central server and data storage device capable of receipt and storage of medical information from multiple external sources, translation of said information into selected formats, transmission of said information and portions thereof in response to internal and external commands for access to said information in response to at least first and second encryption code instructions only;
including providing at least one external input source of medical information in the form of a standard set of medical terminology, said external source including a means for access through a network to and interactive connection for transmission of information with the central server and storage device upon entry of said first encryption code; and
wherein providing secure access by said individual includes providing a patient encryption set compatible only with said server second encryption code, said patient encryption set including a multiple bit hardware device having a unique encryption code, said patient encryption set effective to log onto a computer device programmed with a patient program capable of operating in response to input of the patient encryption set to interactively connect only with the central server and data storage device through a network, said computer programmed to provide a standard set of informational screens having interactive communication instructions for access to data in and input of data into the central server and data storage device uniquely associated with the patent encryption set only.

11. The method of claim 10 wherein the patient program includes a sort program for searching data stored in said central server and storage device based upon portions of key words and key words.

12. The method of claim 10 wherein each category of information is separately connectable to the storage facility, each further including a unique encryption code to achieve access to said storage facility storage device.

13. The method of claim 10 wherein each category of information is separately connectable to the storage facility, each further including the patient encryption set to achieve access to said storage facility.

14. The method of claim 10 including the step of controlling data entry into said storage facility in compliance with a standard medical nomenclature.

15. The method of claim 10 further including the step of bypassing one of said first and second encryption codes for access to information in said storage facility for read only communication therewith.

16. A medical record system comprising, in combination:
(a) a computer, a network, a central server and data storage facility capable of receipt and storage of medical information from multiple discrete external sources via said network, translation of said information into selected formats, transmission of said information and portions thereof in response to internal and external commands via said network for access to said information in said server and storage facility in response to at least a first and a second encryption code instruction;
(b) said computer including means for categorizing the source of medical information by means of a hierarchical protocol, each source having a characteristic quality of complexity;
(c) at least one external input network source of medical information in the form of a standard set of medical terminology, said external source including a means for access comprising an input source through said network to an interactive connection for transmission of said information via the network with the central server and storage facility upon entry of at least one of said first and second encryption codes;
(d) said computer including an unique patient encryption set comprised of at least two separate encryption codes compatible but only in combination with only one of said first and second encryption codes; and
(e) said computer programmed with a patient program capable of operating in response to input of the patient encryption set to interactively connect with the central server and data storage facility through said network, said computer programmed to provide a standard set of informational screens on display devices having interactive communication instructions for access to all medical information into the central server and data storage facility uniquely associated with the patient encryption set only.

17. A method for maintaining personal, integrated medical records for each individual in a class of individuals comprising the steps of:
(a) identifying by means of a computer system a category of medical or drug information that is derived through a network from at least two independent sources, said information capable of association only with each single individual, said category determined via the computer system by the source of said information, at least more than one source being independent from the other sources and each source having a characteristic quality of complexity;
(b) collecting medical information by means of a collection device associated with at least two of said sources for each single individual;
(c) storing said collected information from said sources for each said category for said each said single individual in an electronic storage facility;
(d) updating said collected information in said electronic storage facility via the network from said sources in each said category periodically;
(e) providing secure access by said network for each said single individual to said stored information of each said single individual only pursuant to a programmed security protocol; and
(f) providing permitted access by said network to at least one said category of information only, less than every category, pursuant to a protocol associated with the quality of complexity of said at least one category of information by at least one entity other than the said each single individual as determined by a programmed security protocol of the programmed computer system made available for permitted access to said at least one entity other than said single individual.
